(19) United States
(12) Patent Application Publication
(10) Pub. No.: US 2015/0242832 A1
(43) Pub. Date: Aug. 27, 2015

(54) SYSTEM AND METHOD FOR RECOVERING REFUNDABLE TAXES

(71) Applicant: MasterCard International Incorporated, Purchase, NY (US)

(72) Inventors: Mark CORRITORI, Katonah, NY (US); Geoffrey Mark Iddison, New York, NY (US); Daniel Jason Goodman, White Plains, NY (US); Ranjita Iyer, Chappaqua, NY (US)

(73) Assignee: MASTERCARD INTERNATIONAL INCORPORATED, Purchase, NY (US)

(21) Appl. No.: 14/323,309

(22) Filed: Jul. 3, 2014

(30) Foreign Application Priority Data
Feb. 21, 2014 (GB) 1403074.6

(51) Int. Cl. G06Q 20/20; G06Q 20/40; G06Q 10/08; G06Q 20/34

(52) U.S. Cl. CPC G06Q 20/207; G06Q 20/34; G06Q 20/401; G06Q 10/0831

(57) ABSTRACT

A method for processing a payment transaction relating to a purchase and refunding a tax paid on the purchase comprises: receiving data relating to a payment transaction associated with an electronic payment card; storing said data in a payment transaction record in a data store; analysing the payment transaction record to determine whether the payment transaction is eligible for a tax refund; determining a tax refund value relating to the payment transaction; and coordinating between an issuer associated with the payment card and a tax authority in order to credit an account associated with the electronic payment card with the tax refund value. The invention thereby provides a scheme by which an overseas cardholder can be provided with a refund of the tax paid on eligible purchases in a manner that is user-friendly and transparent to the cardholder.

### TECHNICAL FIELD

The invention relates in general to electronic transactions carried out within the context of a financial authorisation, clearing and settlement system. More specifically, the invention relates to a process for handling the recovery of refundable taxes that have been levied during such electronic transactions for the payment of goods and services.

### BACKGROUND

A feature that is common to the retail industry world-wide is the imposition of a sales tax or value added tax (known as VAT) to the purchases of various goods and services. Such taxes are applied for a variety of reasons such as to discourage or promote spending on certain goods categories, and serve as a significant revenue generator for a respective government. The UK, for example, imposes a ‘value added tax’ (VAT) of 20% on many categories of goods and services that are purchased. Typically such taxes will be variable in order to achieve certain economic objectives.

In some countries these taxes may be refundable to non-resident visitors under certain conditions. Staying with the UK by way of example, the ‘VAT Retail Export Scheme’ permits non-EU residents visiting the UK to recover VAT on goods they buy for personal export outside the EU. The Retail Export Scheme thus contributes to the UK economy by encouraging overseas visitors to buy goods when they visit the UK since the effective cost of those goods is reduced. The EU-wide scheme ensures that goods are taxed only where they are used and prevents ‘double taxation’, which could otherwise occur if goods were taxed in the EU when they are purchased and again in the visitor's home country when imported.

Currently, the process of obtaining a VAT refund on purchases is largely paper-based. In a typical process, when an overseas visitor visits a shop or ‘merchant’ in the UK and wishes to obtain a refund of the VAT levied on the transaction, the retailer and the customer complete a tax recovery document (e.g. HMRC official form VAT407) with details of the transaction. A prerequisite of this, however, is that the retailer participates on the VAT Retail Export Scheme, usually identified by the ‘Tax Free Shopping’ sign.

When leaving the EU, the visitor is required to present the tax recovery document and the goods at UK customs service at their point of departure from the EU for inspection and validation by a customs official. Once the tax recovery document has been approved by customs, the tax recovery document may be sent to the retailer who will then refund the visitor and ‘zero-rate’ the transaction in the business accounts. Some retailers may choose to operate through a third party refund company. Alternatively some retailers may have arrangements with a refund booth at UK departure ports, and perhaps other locations such as shopping malls, which provide visitors with the facility to obtain refunds before leaving the country. Note that other EU countries have similar Retail Export Schemes in place and similar processes exist for many non-EU countries.

As will be appreciated by the above discussion, the process is by-and-large a manual one and requires engagement between retailers and customers to fill in documentation which reduces the effectiveness of the process, reduces take-up and, ultimately, may discourage overseas visitors from spending on big-ticket items in the home country. Thus, there is a need to increase the efficiency of the process.

One proposal is described in U.S. Pat. No. 6,546,373 (B1) in which purchases subject to VAT (or sales tax) made by a traveller are recorded on an electronic transaction card that is loaded with a dedicated software application that is able to record the relevant purchases. During the traveller's visit to a foreign country, the electronic transaction card records the purchases made and accumulates the refundable tax amount. When the traveller leaves the country, the electronic transaction card may be inserted into a suitable terminal which reads the purchase information and manages a tax refund application process including communicating with a suitable taxing authority and tax recover application supplier if appropriate. The traveller may be issued with a tax refund for eligible purchases there and then at the terminal.

It is against this background that the invention has been devised

### STATEMENTS OF INVENTION

In one aspect, the invention provides a method for processing a payment transaction relating to a purchase and refunding a tax paid on the purchase. The method comprises
receiving over a network from a merchant apparatus, data relating to a payment transaction associated with an electronic payment card, and storing said data in a payment transaction record in a data store;
analysing the payment transaction record to determine whether the payment transaction is eligible for a tax refund;
determining a tax refund value relating to the payment transaction; and
coordinating between an issuer associated with the payment card and a tax authority in order to credit an account associated with the electronic payment card with the tax refund value.

The invention may also be expressed as, and therefore also embraces, a system for processing a payment transaction relating to a purchase and refunding a tax paid on the purchase, the system comprising
a merchant apparatus for generating a payment transaction relating to a purchase and to transmit the payment transaction over a network,
a transaction processor configured to receive the payment transaction generated by the merchant apparatus and transmitted to it over the network, wherein the transaction processor is configured to:
store data relating to the payment transaction in a payment transaction record;
analyse the payment transaction record to determine whether the payment transaction is eligible for a tax refund;
determine a tax refund value relating to the payment transaction, and
coordinate between an issuer associated with the electronic payment card and a tax authority in order to credit an account associated with the electronic payment card with the tax refund value.

Advantageously, the invention provides a scheme or process for harvesting data from payment transactions and providing the cardholder relating to the transaction with the facility for refunding the tax that is paid on the purchase. Known systems for claim tax refunds are largely paper based and require significant involvement from both the merchant and from the user at the point of sale. This paperwork burden detracts from the financial incentive for the cardholder to make a tax reclaim which means take up is generally poor. The invention, however, provides a process which is largely transparent to the user by leveraging the existing organisation infrastructure and networks of the entity that manages the payment transactions themselves.

In one embodiment, the step of receiving data relating to a payment transaction may be achieved by monitoring the authorisation processes between the merchant apparatus and an acquirer associated with the merchant apparatus. Therefore, the data is effectively picked out of authorisation messages passing between the merchant and the acquirer. An alternative is for data relating to the payment transaction to be provided after the payment transaction has been concluded. For example, cardholder apparatus may communicate data directly to the transaction processor.

The payment transaction may be verified as being cross border in order to determine eligibility of the cardholder for the tax refund.

In order to assist the process of verification the eligibility of cardholders for participation in the process, the method may include the building of a database of registered participants, such that data relating to a cardholder associated with the electronic payment card and data relating to the merchant apparatus is stored for verification.

One way in which the payment transaction may be analysed is to involve receiving receipt data relating to the payment transaction. The receipt data may be provided in the form of an image as acquired and sent from a suitably equipped electronic device associated with the electronic payment card—e.g. the cardholder's mobile phone or equivalent computing device.

Alternatively, receipt data may be provided to the transaction processor from a data store associated with the merchant apparatus.

Beneficially, from the receipt data one or more data items may be extracted in order to verify eligibility of the payment transaction for the tax refund. For example, a product category data item may be extracted to determine if that product may be eligible for a tax refund. Alternatively or in addition the data item extracted from the receipt data may be the tax refund value.

Although the tax refund process is envisaged to be largely transparent to a cardholder, it may be the case that eligibility for a tax refund cannot be determined immediately. In such circumstances, therefore, the transaction processor may be configured to communicate with an electronic device associated with the electronic payment card in order to provide a notification that the purchased goods need to be inspected at a customs service. In response, the transaction processor may receive a notification from the customs service that indicates whether the purchased goods are cleared for a tax refund.

The transaction processor may be configured to communicate with the tax authority to obtain funding corresponding to the tax refund value. This may occur once the tax refund has been authorised, either automatically by the transaction processor or after goods inspection by the customs service. Alternatively, the transaction processor may communicate with the tax authority to ensure prefunding of the tax refund value.

Within the scope of this application it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

In order that the invention may be more readily understood, reference will now be made, by way of example, to the accompanying drawings in which:

FIG. 1 is a system diagram illustrating the entities involved in a system and process according to an embodiment of the invention;

FIG. 2 is a process diagram illustrating an authorisation leg of a payment transaction including the harvesting of VAT-eligible transactions;

FIG. 3 is a process diagram illustrating the processing of VAT-eligible transactions by a VAT server according to the invention;

FIG. 4 is a process diagram illustrating the interaction between a cardholder client, a customs client and the VAT server;

FIG. 5 is an example of data content of a payment transaction message; and

FIG. 6 illustrates the storage structure of a cardholder entry and a linked payment transaction record.

### DETAILED DESCRIPTION OF THE INVENTION

Specific embodiments of the invention will now be described in which numerous features will be discussed in detail in order to provide a thorough understanding of the inventive concept as defined in the claims. However, it will be apparent to the skilled person that the invention may be put in to effect without the specific details or that variations may be made to those specific features in question. In some instances, well-known methods, techniques and structures have not been described in detail in order not to obscure the invention unnecessarily.

The invention will be described in the context of VAT regime currently operating in the UK, although the skilled person will appreciate that the invention is also applicable to other ‘sales tax’ regimes in other countries. Hereinafter, references to terms such as ‘VAT’, ‘tax’ and the like shall be taken to be a sales tax imposed on goods and services unless otherwise stated and, in general, the term ‘VAT’ shall be used.

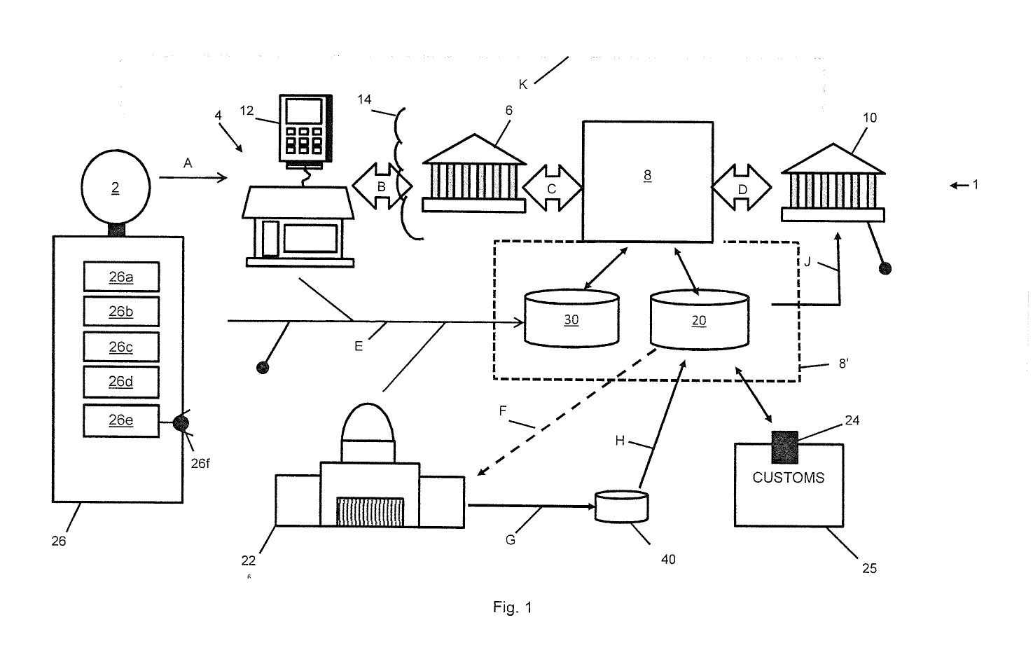

When visiting a foreign country or tax territory that applies VAT on certain goods a foreign traveller may use a payment card to make one or more purchases and then, subsequently, to receive a refund of the VAT paid on the purchases. FIG. 1 illustrates a networked environment including a payment system 1 that facilitates a financial transaction between such a foreign traveller, in this case cardholder 2, and a merchant 4. As would be familiar to the skilled person, the payment system also involves a merchant acquirer bank 6 or, more simply, ‘acquirer’, a transaction processor 8 and a card issuer bank 10 or, more simply, ‘issuer’. The transaction processor 8 may be constituted by a payment processing organisation such as Visa or MasterCard, having suitable processing apparatus, although the skilled person will be aware of other card branding organisations. ‘Visa’ and ‘MasterCard’ are hereby acknowledged as trade marks of their respective organisations.

Before describing the mechanisms and processes that enable the cardholder 2 to reclaim the VAT paid on their purchases, a payment transaction will firstly be described. This skilled person would understand that a payment transaction comprises authorisation, clearing and settlement stages, and an overview of each is provided here for completeness.

### Payment Transaction Process

The payment transaction process starts with the cardholder 2 communicating with the merchant 4 as indicated by arrow ‘A’ in order to pay for goods and services and, more specifically, to seek authorisation for the payment. This may be by way of the cardholder 2 processing their electronic payment card through the merchant's payment system via a chip and pin terminal 12, or by interaction with a digital wallet, for example, using NFC technology, QR codes or other non-contact protocols. Accordingly, the transaction may be conducted under the EMV (Europay Mastercard Visa) standard, as is known in the art, although other transaction protocols may also apply.

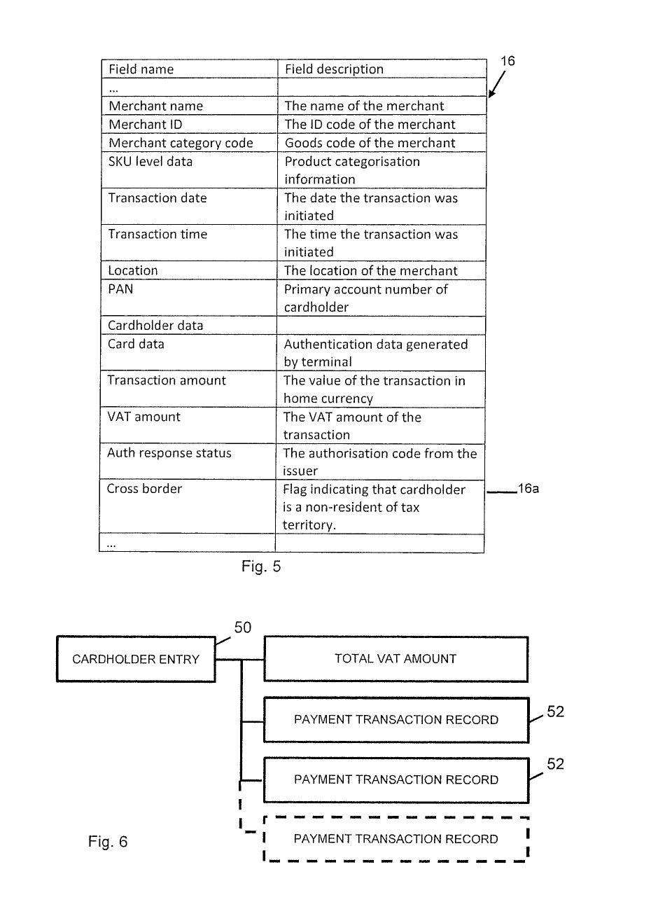

The merchant 4 then completes the necessary authentication checks and constructs or ‘builds’ a payment transaction data structure in the form of an ‘authorisation request message’ and communicates with the acquirer 6 (or ‘merchant's bank’) via the network 14, which may be the internet, in order to obtain an authorization for the payment that the cardholder 2 wishes to make, as indicated by arrow ‘B’. In response, the acquirer 6 then communicates the authorisation request message to the transaction processor 8, as illustrated by arrow ‘C’. An exemplary financial transaction data structure 16 is shown in FIG. 5 and includes the following data fields: merchant name, merchant ID, merchant category code, transaction date, transaction time, location, primary account number or ‘PAN’, cardholder name, card data, transaction amount, VAT amount and authorisation response code, and product categorisation date (SKU-level data). The skilled person will appreciate that further data fields may be included in practice.

At this point the transaction processor 8 communicates (arrow ‘D’) with the issuer 10 of the cardholder's card after it has carried out appropriate validation and security checks. The issuer 10 then carries out necessary credit worthiness checks to ensure that the account balance of the cardholder 2 is sufficient to cover the payment amount and fraudulent activity checks and communicates a response back to the transaction processor 8 (arrow ‘D’) either granting authorization for the transaction or denying authorization. It should be noted that since the process relates to the manner in which VAT-refundable goods are purchased by the cardholder 2 who is resident overseas, it will be appreciated that the issuer 10 may not be resident in the same country as the merchant. More likely, in fact, that the issuer 10 is based in the same country as the cardholder 2 has residency, although this is not essential.

The payment transaction will also include the authorization/denial from the issuer 10, and the transaction processor 8 communicates back to the acquirer 6 (arrow ‘C’). Having received the payment transaction including authorization/denial from the issuer 10 the acquirer 6 then communicates the transaction back to the merchant 4 (arrow ‘B’). At this point, the merchant 4 has received the authorization for the original transaction and so the merchant 4 communicates the authorization to the user/cardholder 2, as illustrated by arrow ‘A’, thereby completing the authorisation stage of the payment transaction which enables the cardholder 2 to take their goods.

As is known, the authorisation stage of the payment transaction is followed by a clearing and settlement process. These are not central to the inventive concept and so will not be described here in detail. However, a brief overview will be provided for completeness.

### Clearing

Following completion of the authorisation stage of the payment transaction between the cardholder 2 and the merchant 4, the transaction undergoes ‘clearing’. Typically within a day of authorisation, the merchant 4 batch-transmits all of their stored payment transactions that are associated with the organisation represented by the transaction processor 8 to the acquirer 6. The acquirer 6 then batches and sends the payment transactions to the transaction processor 8 which validates the accuracy of the transaction information submitted by the acquirer 6 in order to reconcile funds between issuers and acquirers. This reconciliation process balances funds between payment parties on a regular basis.

### Settlement

Typically within one to four days of authorisation, and after transactions have been cleared, the transaction processor calculates the debited and credited amounts between issuers and acquirers, also termed the ‘net settlement position’. During this process, the issuer is informed of the funds to be debited from cardholder accounts to settle transactions and the acquirer is informed of the funds to be credited to merchant accounts net of fees levied by the transaction processor 8.

### VAT Data Capture

Having described the way in which a payment transaction may be propagated between the merchant 4 and the issuer 10 on behalf of the cardholder 2, it will now be explained how the VAT paid on the purchase may be refunded to the cardholder 2.

As discussed above, an ‘overseas’ consumer/cardholder 2 may purchase goods for which they wish to claim back the VAT, which is currently 20% in the UK. The invention provides a means for the cardholder 2 to make such a VAT reclaim by way of an electronic system or platform which avoids the need to complete a paper-based VAT refund application on the premises of the merchant 4 and provides a much more flexible and swift resolution for the cardholder 2.

This platform and associated processes will now be described in more detail.

The main component of the platform is constituted by the transaction processor 8 which provides the link, by way of a VAT platform server 20 (hereinafter ‘VAT server’), between payment transactions and other parties within the environment such as the a tax authority client 22 which, collectively, includes a customs client 24 situated at a customs service 25 at the port of exit of the country. In this case, the tax authority client 22 can be considered to be HMRC (Her Majesty's Revenue and Customs). The platform also includes a cardholder device 26 which may be a mobile electronic device such as a smartphone, tablet computer or the like. As such, the cardholder device includes a user interface 26a, such as a touchscreen, an application module 26b configured to run a software application on the device 26, a memory module 26c configured to store data generated during the execution of the software application, a communications interface module (CIM) 26d configured to communicate with a suitable communications network such as the internet, and a imaging module 26e that is interfaced to a suitable camera 26f that may be integrated to the mobile device 26e, as is standard fitment on smartphones currently on the market.

In overview, the VAT server 20 is operable to harvest VAT data relating to the payment transaction and also to coordinate with the cardholder device 26, the customs service client 24, and the tax authority client 22 to facilitate a VAT refund to the cardholder 2.

To enable the VAT server 20 to act on behalf of the tax authority client 22 in issuing VAT refunds to the cardholder 2 it is necessary for the VAT server 20 to establish a knowledge base to build up profiles of various involved parties and, for this purpose, the VAT server 20 manages the knowledge base in the form of database 30 which gathers information from relevant parties or ‘stakeholders’.

### Cardholder/Merchant Enrolment Process

In this embodiment, prior to the commencement of a payment transaction from which the VAT may be refunded, as discussed above, the cardholder 2 is required to enroll into the knowledge base 30 which forms part of the business structure of the transaction processor 8 illustrated here by the dashed boundary line 8′. The knowledge base 30 provides access to ‘know your customer’ data for relevant participants involved in the tax refund process. In this example this participants are the cardholder 2, the merchant 4, the acquirer 6, the transaction processor 8, the issuer 10 and the tax authority client 22. Here the knowledge base 30 is shown as being part of the organisational structure of the transaction processor 8 connected to it via a suitable internal communications system. Alternatively it is envisaged that the knowledge base 30 may be a cloud-hosted system and, furthermore, that it may be hosted by a different organisation to the transaction processor 8, although linked through a suitably trusted relationship.

The cardholder 2 provides a variety of data items during the enrolment/registration process. For instance, the cardholder 2 may provide such data items as: name, address, country of residence, contact details, card details of the payment card which they wish to be registered, passport information and the like. Other data items would be apparent to the skilled person.

All such data items are combined into a suitable cardholder entry in the knowledge base 30 that is accessible by the transaction processor 8. The enrolment process is in essence an administrative exercise and, as such, may be a paper-based process in which the cardholder 2 completes a suitable registration form and sends this to the transaction processor 8 by mail for processing. Alternatively, and more efficiently, the enrolment process may be carried out in online environment and here, it is envisaged that the cardholder 2 will perform the enrolment process by way of a suitable software application or ‘app’ provided on the mobile device 26.

Similarly, in the enrolment/registration process of the merchant 4, the merchant 4 also provides a variety of data items that are required by the knowledge base 30. The merchant may provide such data items as identification data, merchant ID (MID), one or more merchant category codes (MCCs) which identify the types of goods that the merchant sells, which may be both eligible and ineligible for tax refund. It is envisaged that the merchant 4 may provide further information to the knowledge base 30 such as tax ID information and also SKU-level data which indicates product description information. Although the merchant 4 may provide the necessary information to the knowledge base 30 via communication with the transaction processor 8, for example as part of a formalised paper-base or online data input process, it is envisaged that the data may also be provided via a secure integrated communication channel established between the merchant and the transaction processor 8/knowledge base 30.

The enrolment process therefore harvests data from the cardholder 2 in particular, but also the merchant 4, so that these parties may be pre-vetted and thereby authorised to participate in the tax refund process. Thus, the tax authority 22 and the issuer 10 can contribute certain data requirements into the knowledge base 30 that must be satisfied for cardholders 2 and merchants 4 to participate in the process, and the transaction processor 8 is therefore able to implement risk management processes to evaluate cardholders and ensure that they have a suitable low risk profile. Here, the data flows for each of the parties relating to the enrolment process are indicated in FIG. 1 by the convergent arrows referenced ‘E’.

### Identification of Payment Transactions Eligible for VAT Refund

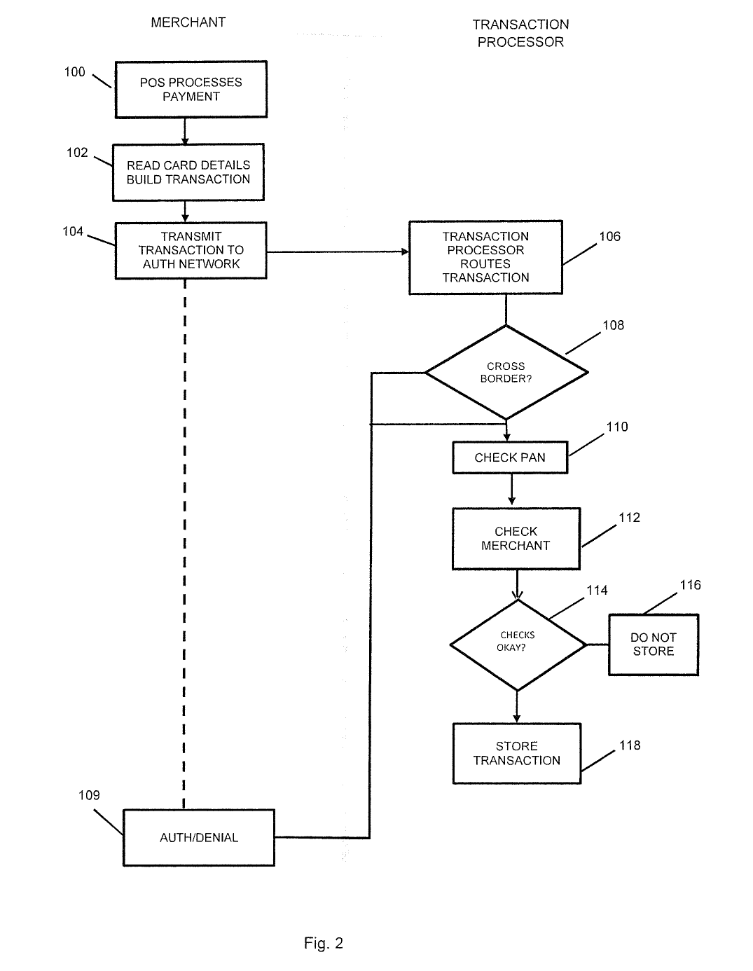

Having described the process by which the knowledge base 30 is established, it will now be explained how VAT data is harvested by the VAT server 20 from the payment transaction propagated between the merchant 4 and the issuer 10. Reference will be made to FIG. 1 and also the process diagram of FIG. 2.

In overview, VAT data is harvested from the payment transaction as it is communicated along the chain from the merchant 4, the acquirer 6, the transaction processor 8 and the issuer 10.

As illustrated in FIG. 2, the payment transaction is initiated at step 100 as described above, at which point the terminal 12 at the merchant 4 reads details from the cardholder's card and builds a payment transaction in the form of an authorisation request message at step 102 and transmits the payment transaction to the acquirer 6 via the payment network 14 at step 104.

The transaction processor 8 performs its usual validation and routing of the payment transaction at step 106. However, at this point the transaction processor 8 performs the additional check to determine whether the payment transaction is ‘cross border’, as shown by step 108. By this, it is meant that the cardholder 2 is not a resident of the same tax territory as the merchant 4, for example is a non-EU resident in this specific example.

The determination as to whether the payment transaction is cross border may be achieved in various ways. However, it is currently envisaged that the the transaction may be recognised as cross border by reading information from the card data relating to the Bank Identification Number or ‘BIN’ which is a unique reference indicative of the issuing bank of the card and corresponds to the first six digits in the PAN. Alternatively, the acquirer 6 may set a flag in the payment transaction if it detects that the cardholder's details meet the necessary requirements, as indicated at field 16a in the data structure 16 in Figure

Whether or not the payment transaction is determined to be cross border, it is allowed to proceed through the established authorisation stage which terminates at step 109. However, if the payment transaction is determined to be cross border, the transaction processor 8 is configured to carry out a series of further checks to confirm if the cardholder 2 and the merchant 4 that are identified in the payment transaction are eligible to progress into the VAT refund scheme.

To this end, firstly the transaction processor 8 queries the knowledge base 30 at step 110 to confirm whether the PAN identified in the payment transaction is one that the cardholder 2 has registered during the enrolment process discussed above. Similarly, at step 112, the knowledge base 30 is queried to confirm that the merchant ID identified in the payment transaction corresponds to a valid merchant that has registered with the transaction processor 8 by way of the enrolment process that it intends to participate in the VAT refund scheme.

As indicated at steps 114 and 116, if the payment transaction includes either an unregistered PAN or merchant ID, then the payment transaction is not stored. However, if both the PAN and merchant ID are determined as registered in the knowledge base 30, the transaction processor stores the payment transaction as a payment transaction record linked to a cardholder entry in the VAT server 20 at step 118. The cardholder entry and the payment transaction record are depicted in FIG. 6 as reference numerals 50 and 52 respectively. Note that the cardholder entry 50 may include more than one payment transaction record 52 in the event that the cardholder makes more than one potentially VAT eligible purchase.

Collection of VAT data

The role of the VAT server 20 is to act as a link between the parties involved in the VAT refund scheme, that is to say the cardholder 2, the merchant 4, the issuer 10, the tax authority client 22 and the customs service 25, to gather data regarding payment transactions that may be eligible for a VAT refund, to verify that eligibility, and to coordinate between the parties to effect a refund of the VAT to the cardholder 2.

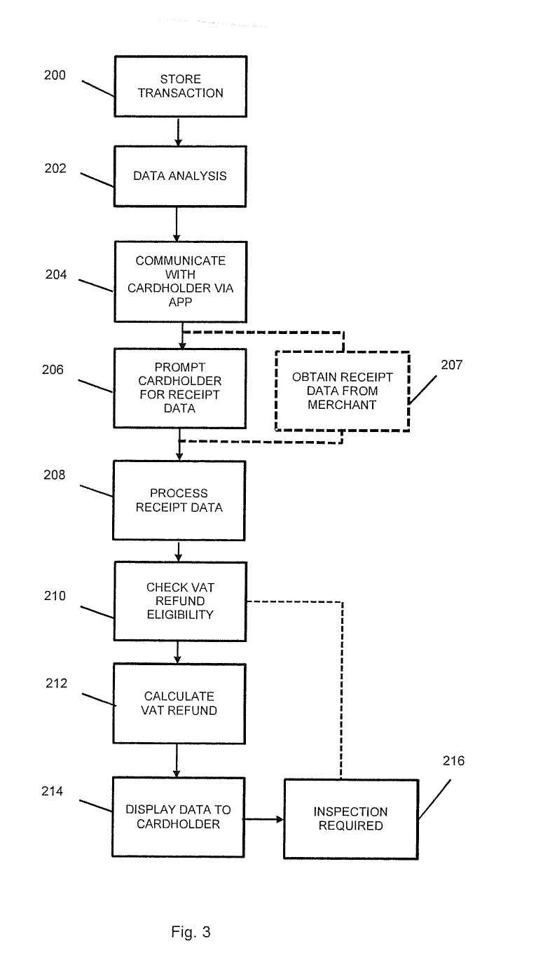

FIG. 2 and the related discussion above describes the process by which payment transactions that are eligible for a VAT refund are identified during the authorisation stage and stored in the VAT server 20. Following identification of an eligible payment transaction in this manner, the VAT server 20 is operable to collect VAT data in order to more fully populate the payment transaction record. A process by which this can be achieved is illustrated in FIG. 3, beginning at step 200, and which corresponds to step 118 in FIG. 2, at which the payment transaction record is stored in the VAT server 20 as part of a cardholder data entry.

The VAT server 20 then performs data analysis on the payment transaction record 52 at step 202 to extract data to form the basis of a communication to the mobile device 26 of the cardholder 2. In this example, the PAN is extracted from the payment transaction record 52 and this is cross referenced with the knowledge base 30 to identify the specific software app as implemented on the software application module 26b of the mobile device 26 and that is linked to the PAN. Also extracted are relevant data items such as the merchant name, the transaction details such as time, date and location, and the transaction amount. Hereinafter, the software application will be referred to as the ‘VAT app’.

Having extracted the relevant data at step 204, the VAT server 20 then communicates with the cardholder 2 at step 204 via the VAT app carried on the cardholder's mobile device 26. Here, the VAT app may present the cardholder 2 with a message that notifies them that they have made a purchase at a specific merchant and that the purchase may be eligible to reclaim VAT.

At this point, the process may take one of two alternative paths, which are largely determined by the capabilities of the payment terminal 12 located at the merchant. However, the objective of each alternative path is to obtain information about the transaction from the physical receipt that is provided to the cardholder 2 following the successful authorisation of the payment transaction.

The first alternative path is represented by step 206 at which point the VAT server 20 prompts the user, by way of the VAT app, to take a picture of the receipt that they obtained from the purchase at the merchant 4. The cardholder 2 duly takes an image of the receipt using the integrated camera 26f on the mobile device 26 and transfers the receipt image data to the VAT server 20 using the VAT app. In response to receiving the receipt image data, the VAT server 20 stores the receipt image data as part of, or so as to by linked to, the payment transaction record.

Following receipt of the receipt image data from the mobile device 26, the VAT server 20 then processes the receipt image data at step 208 in order to extract relevant information. It is envisaged here that the VAT server 20 will implement optical character recognition (OCR) techniques, as would be known to the skilled person, to effectively ‘read’ the receipt and extract data items such as: i) a product category code such as a ‘stock keeping unit’ (SKU) identifier, ii) purchase amount, and iii) VAT paid.

In essence, therefore, at this point in the process the VAT server 20 identifies the type of goods to which the purchase relates and the VAT that has been paid in the purchase. So, the VAT server is therefore able, at step 210 to determine whether the goods that have been purchased are eligible for a refund of the paid VAT. To achieve this, the VAT server 20 preferably cross references the SKU identifier with an internally-stored goods eligibility table. If the VAT server 20 determines that the goods identified by the SKU identifier are indeed eligible for a VAT refund, then the amount of the VAT refund due to the cardholder 2 is calculated at step 212. The VAT refund due will now be referred to as VAT AMOUNT.

The VAT AMOUNT parameter will be stored by the VAT server 20 as part of the payment transaction record.

It will be appreciated that the process will be run each time a cardholder makes a purchase so, in the case of multiple VAT eligible purchases being made, a plurality of payment transaction records will each include a VAT AMOUNT parameter.

In order to keep track of the total amount of VAT to which a cardholder is entitled, the cardholder entry will include a TOTAL VAT AMOUNT parameter which serve as a running total of the VAT that is due to be refunded to the cardholder 2. The TOTAL VAT AMOUNT is therefore a cumulative total for the VAT AMOUNT in respect of each payment transaction record.

Once VAT AMOUNT has been calculated, the VAT server 20 once again communicates to the cardholder 2 via the VAT app, as shown as step 214, in order to display to the cardholder the amount of VAT refund which they may be eligible for in respect of the most recent purchase, and also the total VAT refund if multiple purchases have been made.

In some instances, the purchased goods may belong to a category which cannot be identified immediately as eligible for a VAT refund, for example the purchase value may be above a predetermined threshold, or it may not be possible to categorise the goods from the receipt data, for example if the receipt data contacts brand names rather than product descriptions. In such circumstances, it is necessary for the customs service 25 at the port of exit to visually inspect the goods in order to indicate that they are eligible for a VAT refund. If the VAT server 20 determines that VAT eligibility is not automatic, and that the customs service 25 will need to inspect the goods in question, it will also communicate this fact to the cardholder 2 by way of the VAT app at step 216.

It will be appreciated here that the above process explains one way in which transaction data may be obtained from the cardholder 2 by the VAT server 20. Alternative methods are also envisaged. For example, during the interaction between the cardholder 2 and the merchant 4, the merchant may produce a receipt that carries a machine readable code, such as a barcode or QR code. This code may contain all the relevant data required by the VAT server 20 and can be read with suitable software by the VAT app on the mobile device 26 and transmitted to the VAT server 20.

A further alternative is for the merchant 4 POS system to communicate with the mobile device 26 with suitable NFC (near field communication) technology to transmit the receipt data directly to the VAT app which then can provide the receipt data to the VAT server 20. Still other alternatives are possible.

The process steps 200 to 216 will be repeated for each purchase made by the cardholder 2. Therefore, the cardholder 2 is kept up-to-date on the VAT AMOUNT they the will be able to reclaim when their trip is over.

Referring to step 206 at which point transaction data from the receipt is obtained from the cardholder 2 via the mobile device 26, an alternative path to obtain this information is presented at step 207. At this step, instead of sourcing data from the cardholder 2 my means of the receipt relating to the purchase, the VAT server 20 may take a more direct approach by sourcing transaction data directly from the merchant 4 which holds suitable transaction data on its POS system. So, the merchant 4 may transmit the necessary information regarding product description and VAT amount to the VAT server 20 directly.

### Refund of VAT on Purchase at Port of Exit

The above description explains how the transaction processor 8, by means of the VAT server 20, obtains information relating to purchases made by the cardholder and, importantly, how it determines the VAT AMOUNT that may be due to the cardholder 2 upon leaving the country. It will now be explained how the cardholder 2 is able to claim a refund of the VAT paid on their purchase or purchases.

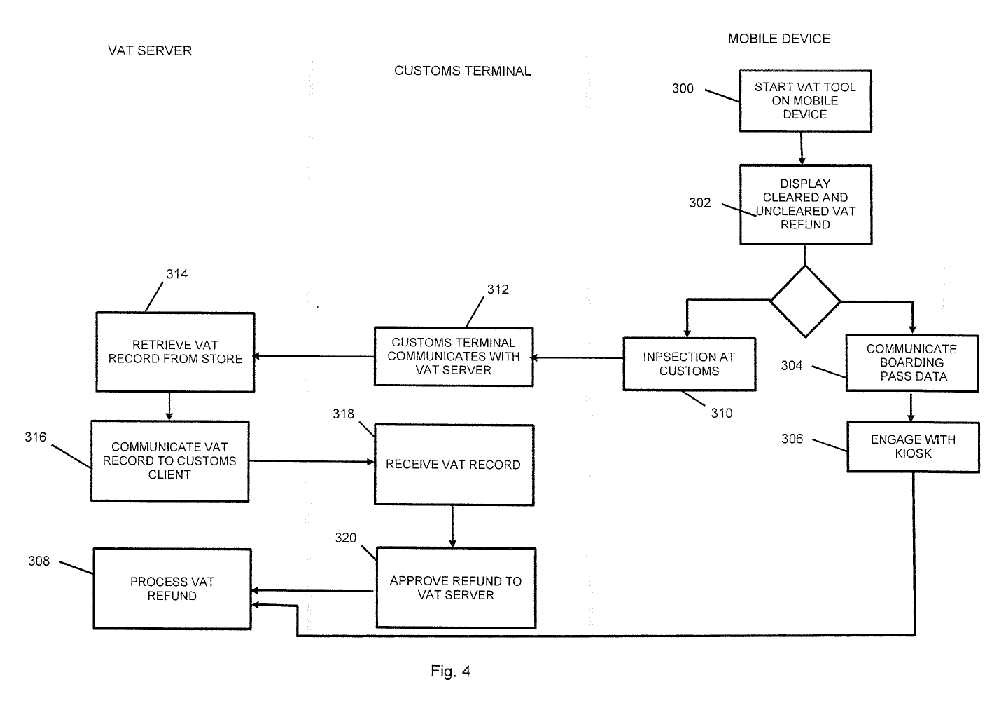

Turning now to FIG. 4, the process is initiated by the cardholder 2 opening the VAT app of their mobile device, illustrated here at step 300. The VAT app includes a function that takes the cardholder 2 through a procedure that validates their purchases for a VAT refund which the user selects in circumstances where they are ready to leave the country.

At step 302, the VAT app indicates to the cardholder the total amount of VAT that is eligible for a refund, as is determined by the VAT server 20 as described in the previous section. At this point, the VAT app may also display to the cardholder 2 any items for which VAT has been flagged as needing visual inspection by the customs service 25.

In respect of the purchased goods that do not require visual inspection, the cardholder 2 is prompted at step 304 to upload boarding pass data. This may be achieved by the cardholder 2 capturing a visual image of their boarding pass using the integrated camera 26f on the mobile device 26 and transmitting that to the VAT server 20 or, alternatively, appropriate permission may be provided to access an e-boarding pass application provided on the mobile device 26. This step enables the boarding pass information to be validated against suitable airline or government databases.

Once the boarding pass data has been validated by the VAT app, the cardholder 2 is able to interact with a kiosk within the port of exit to complete the VAT refund process at step 306. By way of the VAT app or the kiosk, this may also include self-certifying that the purchased goods are now to be exported from the tax territory and are for personal use. Although not shown here, such a kiosk is an automated facility provided by the transaction processor 8 in the port of exit having the functionality to read data from the cardholder's card by established techniques and so detect that the cardholder 2 has processed the VAT eligible items through customs. The kiosk then communicates to the VAT server 20 which is then able to process the VAT refund for the cardholder at step 308, as will be described.

Returning to step 302, there is a possibility that some of the purchased goods will have been identified by the VAT server 20 as requiring visual inspection by the customs service 25 situated at the port of exit. In these circumstances, the VAT app prompts the cardholder 2 at step 310 to present the relevant purchased goods at the customs service.

The customs service client 24 is equipped with a suitable facility either to communicate directly with the VAT app on the mobile device 26 or, alternatively, with an electronic card reader. In either case, the customs service client 24 reads the cardholder data and communicates with the VAT server 20, at step 312, in order to receive the payment transaction record stored 52 at the VAT server 20 relating to the goods that have been identified for visual inspection. It should be noted that the VAT server 20 may communicate a plurality of payment transaction records to the customs service client 24 if more than one purchase is required to be inspected by the customs service 25.

In response from the request from the customs service client 24, the VAT server 20 retrieves the one or more payments transaction records at step 314 and returns the data to the customs service client 24 at step 316.

At step 318 the customs service client 24 receives the one or more payment transaction records from the VAT server 20 and the customs service 25 is presented with a list of the transactions embodied in the payment transaction records including the receipt data that has been collected from the cardholder, or the merchant, as described above. It is therefore possible for the customs service 25 to visually inspect all of the flagged goods to confirm that they are eligible for a VAT refund. To this end, the payment transaction records that are displayed by the customs service client 24 are updated to confirm or deny VAT refund eligibility and the VAT AMOUNT may be confirmed for each eligible payment transaction.

Once the customs service 25 has processed each payment transaction record, the data is transmitted back to the VAT server 20 at step 320 so it can implement the refund of the VAT in respect of the eligible payment transactions.

At step 308, the VAT server 20 has determined which of the payment transactions are eligible for a VAT refund by way of two sources: first the transmission from the kiosk at step 306, and also the transmission from the customs service client 24 at step 320. Furthermore, the VAT server 20 knows at this point that the cardholder has cleared customs and will soon be leaving the country. As a result the VAT server 20 is now able to process a payment of the TOTAL VAT AMOUNT to the cardholder 2.

It is currently preferred that the fund provisioning for refunding VAT to the cardholder 2 will be on the basis of pre-funding by the tax authority client 22. To this end, and with reference to FIG. 1, an account 40 is established by or on behalf of the tax authority client 22 through a suitable payment gateway provider such as DataCash®. This account 40 may be funded by the tax authority client 22 at a predetermined frequency, for example on a monthly basis, or more frequently.

Although the payment from the tax authority client 22 may be automatic, based on predicted levels of required funding, payment may also be made conditional on a request from the VAT server 20. Accordingly, in order to trigger funding of the account 40 by the tax authority client 22, the VAT server 20 may submit a payment request, as shown at arrow ‘F’ in FIG. 1, to the tax authority client 22 through established electronic invoicing infrastructures which comprise sufficient detail regarding the refund-eligible payment transactions to serve as an auditing function. In response, the tax authority client 22 would then fund the account 40 as necessary, as illustrated by arrow ‘G’.

Following funding of the account 40, the transaction processor 8, via the VAT server 20, is able to draw down funds from the account 40, as illustrated at arrow ‘H’ in FIG. 1, in order to make payment to the issuer 10, at arrow ‘J’. The VAT server 20 may at this point deduct a fee from the refunded VAT AMOUNT in respect of the service provided to the cardholder 2. In turn, the issuer 10 then credits the account of the cardholder 2, as is depicted here by the arrow ‘K’.

In the above embodiment, the payment to the issuer 10 is effectively ‘pre-funded’ by the tax authority client 22. So, the account 40 must be in funds before the VAT server 20 is able to make payment to the issuer 10 and it is envisaged that the tax authority client 22 would place the account 40 in funds sufficient to cover a predetermined number of days of expected VAT refunds. However, in an alternative embodiment, the issuer 10 may credit the cardholder 2 in advance of receiving funding by the VAT server 20. This will have the effect of increasing the speed by which the cardholder's account is credited with the VAT refund. Still alternatively, the VAT server 20 may pre-fund the issuer 10 for the amount of the VAT refund and then draw down the required funds retrospectively from the account 40. As an alternative to the account 40, the tax authority client 22 may be configured to transfer via a suitable bank-to-bank transfer process, such as ACH (Automated Clearing House) or CHAPS (Clearing House Automated Payment System) at a predetermined frequency.

The electronic processing and management of tax refunds according to the invention offers many benefits. Importantly, the process enables the cardholder 2, more specifically the cardholder's account as provided by the issuer, to be credited with funds equal to the tax paid on overseas purchases with only minor input by the cardholder 2 at the port of exit of the country. To achieve this, the established business infrastructure of the transaction processor 8 is used to provide a more efficient system to coordinate and fulfil tax refunds for cardholders that are a member of its network.

Compared to existing systems, where the cardholder 2 must complete hard-copies of the appropriate forms to record the purchases and then present these forms for inspection at customs, the invention provides a more transparent process for the cardholder which encourages take up by consumers when travelling. What is more, the cardholder receives the tax refund swiftly, typically within one or two billing cycles, which is faster than is currently the case with paper-based methods with or without using a tax refund agency.

Furthermore, since the tax refund scheme operates through an existing cooperative network of card-issuing banks, acquirers, merchants and payment processors, which are augmented through the knowledge network, there is increased assurance over the identity of the cardholder who is making the tax refund claim and control over the use of the card. As such, where a card is used to purchase goods under the scheme and then is used subsequently to claim a refund of the purchase tax, there is established traceability of the individual using the card. This traceability acts as a significant deterrent to fraudulent claims from consumers and provides greater traceability and transparency than the paper-based schemes which, typically, only require passport details as the form of identification. The knowledge network also enables suitable risk-based analytics to be provided to the customs service which can be used to determine a risk score which the customs service can use as an additional factor in the approval of the VAT refund procedure.

A significant advantage of the ‘automated’ tax refund scheme described herein is that the merchant is required to perform less administrative work compared with the current paper-based system since there is a reduction in paperwork that needs to be completed at the point of sale. Not only is this an operational burden for the merchant but it is usually considered difficult for the merchant to implement the process in a way that complies fully with the requirements of the tax authority. The ‘automated’ scheme as described above would remove the need for the merchant to create manual document and would simply require the merchant to register with the scheme.

Since the administrative burden on merchants is reduced, it is envisaged that the numbers of merchants willing to participate in the tax refund scheme will increase, as will the geographical distribution of the network of merchants. These factors will likely encourage retail shopping by international consumers. In turn, this is likely to lead to a wider range of goods that are eligible for vat refunds and may increase market competition for those goods that will benefit the consumer.

It is envisaged that the electronic tax refund process may operate in parallel with an established ‘paper-based’ equivalent scheme pending increased take up of the electronic scheme to a stage that there is justification for disbanding the paper-based counterpart.

The invention also confers benefits for the tax authority since it is no longer required to inspect the paperwork and purchased goods in respect of cardholder that are enrolled in the tax refund scheme of the transaction processor. This reduces the volume of transactions which the tax authority must process and, thus, reduces its operational costs.

Some variants to the specific embodiments described above have already been explained. However, the skilled person will appreciate that other modifications may be made to the specific embodiments without departing from the invention, as defined by the claims

It has been described above with reference to FIGS. 1 and 2 that the payment transaction is stored at the VAT server 20 if the PAN and the merchant ID of the payment transaction are identified as being enrolled with the knowledge base 30.

However, it is envisaged that it will also be possible for a cardholder still to obtain a VAT refund through the process described above even if the cardholder and/or the merchant is not registered into the knowledge base 30 at the time of initiation of the payment transaction. For example, it is envisaged that the transaction processor 8 will be able to harvest data regarding both the cardholder and the merchant from the receipt image sent to it by the cardholder. In this case, the cardholder may have a device running the VAT app and this may be configured to upload all necessary data to the VAT server 20 even though the VAT server 20 may have no knowledge of the transaction gathered through the usual route of the authorisation stage. . . .

In the above embodiments, it is described that the payment transaction is initiated through the use of an electronic payment card, for example a chip and pin card that is known to the skilled person. However, although the description is set in the context of using physical payment cards, it will be appreciated that this is not necessarily the case and the payment card may also be a non-physical card. For example, the non-physical card may take the form of a payment card that has been ‘digitized’ or ‘on-boarded’ onto a mobile wallet device, or it may be a ‘virtual’ payment card having a virtual card number.

The ‘VAT app’ described above that is implemented on the cardholder's mobile electronic device 26 performs the main role of interfacing with the cardholder to i) display the potential VAT refund, ii) prompt for upload of receipt data, and iii) prompt for boarding pass access and the like. However, it will be appreciated that the VAT app may be provided with further features to enhance the cardholder's shopping experience. For example, the VAT app could be configured to display to the cardholder eligible merchant in their vicinity using GPS data and knowledge of the location of the merchant's as obtained from the knowledge base 30.

1. A method for processing a payment transaction relating to a purchase and refunding a tax paid on the purchase, the method comprising:
receiving over a network from a merchant apparatus, data relating to a payment transaction associated with an electronic payment card, and storing said data in a payment transaction record in a data store;
analysing the payment transaction record to determine whether the payment transaction is eligible for a tax refund;
determining a tax refund value relating to the payment transaction; and
coordinating between an issuer associated with the payment card and a tax authority in order to credit an account associated with the electronic payment card with the tax refund value.

2. The method of claim 1, wherein receiving data relating to a payment transaction comprises monitoring an authorisation process between the merchant apparatus and an acquirer associated with the merchant apparatus.

3. The method of claim 1, wherein receiving data relating to a payment transaction includes verifying that the payment transaction is a cross-border payment transaction.

4. The method of claim 1, further including building a database of registered participants, such that data relating to a cardholder associated with the electronic payment card and data relating to the merchant apparatus is stored for verification.

5. The method of claim 1, wherein the payment transaction includes a primary account number (PAN) associated with the electronic payment card and a merchant ID associated with the merchant apparatus, and wherein the step of receiving data relating to a payment transaction further includes verifying that the primary account number and the merchant ID correspond to registered participants.

6. The method of claim 1, wherein analysing the payment transaction record includes receiving receipt data relating to the payment transaction.

7. The method of claim 6, wherein the receipt data is provided as an image from an electronic device associated with the electronic payment card.

8. The method of claim 6, wherein the receipt data is provided by a data store associated with the merchant apparatus.

9. The method of claim 6, including analysing the receipt data to extract one or more data items relating to the payment transaction.

10. The method of claim 9, wherein the extracted one or more data items includes a product category data item.

11. The method of claim 10, further including verifying that the extracted product category data item is eligible for a tax refund.

12. The method of claim 9, wherein the one or more extracted data items includes the tax refund value.

13. The method of claim 1, further including communicating the tax refund value to a cardholder electronic device associated with the electronic payment card.

14. The method of claim 1, further including providing a notification to the cardholder in the event that the purchased goods corresponding to the payment transaction require visual inspection by a customs service.

15. The method of claim 14, wherein, in the event that the purchased goods require visual inspection by a customs service, receiving a notification from the customs service that indicates whether the purchased goods are cleared for a tax refund.

16. The method of claim 1, wherein the coordinating step includes communicating the payment transaction record to the issuer in order for the issuer to credit an account associated with the cardholder with an amount corresponding to the tax refund value.

17. The method of claim 1, wherein the coordinating step further comprises communicating with the tax authority to obtain funding corresponding to the tax refund value.

18. A system for processing a payment transaction relating to a purchase and refunding a tax paid on the purchase, the system comprising:
a merchant apparatus for generating a payment transaction relating to a purchase and to transmit the payment transaction over a network,
a transaction processor configured to receive the payment transaction generated by the merchant apparatus and transmitted to it over the network, wherein the transaction processor is configured to:
store data relating to the payment transaction in a payment transaction record;
analyse the payment transaction record to determine whether the payment transaction is eligible for a tax refund;
determine a tax refund value relating to the payment transaction,
coordinate between an issuer associated with the electronic payment card and a tax authority in order to credit an account associated with the electronic payment card with the tax refund value.

19. The system of claim 18, wherein the transaction processor is further configured to verify that the payment transaction is a cross-border payment transaction.

20. The system of claim 18, wherein the transaction processor is configured to build a database of registered participants, such that data relating to a cardholder associated with the electronic payment card and data relating to the merchant apparatus is stored for verification

21. The system of claim 20, wherein the payment transaction includes a primary account number (PAN) associated with the electronic payment card and a merchant ID associated with the merchant system, and wherein the transaction processor is configured to verify that the primary account number and the merchant ID correspond to registered participants.

22. The system of claim 18, wherein the transaction processor is configured to receive receipt data relating to the payment transaction.

23. The system of claim 22, further including an electronic device associated with the electronic payment card, wherein the electronic device is configured to acquire the receipt data and transmit the receipt data to the transaction processor.

24. The system of claim 23, wherein the electronic device includes a camera so as to provide receipt data in an image format.

25. The system of claim 22, wherein the receipt data is provided to the transaction processor from a data store associated with the merchant apparatus.

26. The system of claim 22, wherein the transaction processor is configured to analyse the receipt data to extract one or more data items relating to the payment transaction.

27. The system of claim 26, wherein the one or more extracted data items includes a product category data item.

28. The system of claim 27, wherein the transaction processor is configured to verify that the extracted product category data item is eligible for a tax refund.

29. The system of claim 26, wherein the one or more extracted data items includes the tax refund value.

30. The system of claim 18, whether the transaction processor is configured to communicate the tax refund value to an electronic device associated with the electronic payment card.

31. The system of claim 18, wherein the transaction processor is configured to provide a notification to an electronic device associated with the electronic payment card in the event that the purchased goods corresponding to the payment transaction require visual inspection by a customs service.

32. The system of claim 31, wherein the transaction processor is configured, in the event that the purchased goods require visual inspection by a customs service, to receive a notification from the customs service that indicates whether the purchased goods are cleared for a tax refund.

33. The system of claim 18, wherein the transaction processor is configured to communicate the payment transaction record to the issuer in order for the issuer to credit an account associated with the electronic payment card with an amount corresponding to the tax refund value.

34. The system of claim 18, wherein the transaction processor is configured to communicate with the tax authority to obtain funding corresponding to the tax refund value.
